(19) United States
(12) Patent Application Publication
(10) Pub. No.: US 2025/0073689 A1
(43) Pub. Date: Mar. 6, 2025

(54) GLASS INSULATION FILM THAT UTILIZES NEGATIVE IONS TO REMOVE FORMALDEHYDE AND PREPARATION METHOD THEREOF

(71) Applicant: Guangdong ZCHC New Materials Co., Ltd., Dongguan (CN)

(72) Inventors: Xinyou YUAN, Dongguan (CN); Xianrui CHENG, Dongguan (CN); Ziyue JIANG, Dongguan (CN); Junliang CHEN, Dongguan (CN)

(73) Assignee: Guangdong ZCHC New Materials Co., Ltd., Dongguan (CN)

(21) Appl. No.: 18/426,686

(22) Filed: Jan. 30, 2024

(30) Foreign Application Priority Data
Sep. 5, 2023 (CN) 2023111365821

(51) Int. Cl. B01J 35/00; B01J 21/06; B01J 23/00; B01J 23/02; B01J 23/18; B01J 31/02; B01J 31/06; B01J 31/38; B01J 35/39; B01J 35/45; B01J 37/00; B01J 37/02; B01J 37/04

(52) U.S. Cl. CPC B01J 35/19; B01J 21/063; B01J 23/002; B01J 23/02; B01J 23/18; B01J 31/0274; B01J 31/06; B01J 31/38; B01J 35/39; B01J 35/45; B01J 37/0009; B01J 37/0219; B01J 37/0228; B01J 37/0244; B01J 37/04

(57) ABSTRACT

Provided are a glass insulation film that utilizes negative ions to remove formaldehyde and a preparation method thereof. The glass insulation film that utilizes negative ions to remove formaldehyde has a composite structure, which includes a transparent film substrate, an insulation coating, an anion coating, and a protective film layer in sequence from bottom to top that are integrally formed.

### CROSS REFERENCE TO RELATED APPLICATION

This patent application claims the benefit and priority of Chinese Patent Application No. 2023111365821 filed with the China National Intellectual Property Administration on Sep. 5, 2023, the disclosure of which is incorporated by reference herein in its entirety as part of the present application.

### TECHNICAL FIELD

The present disclosure relates to the technical field of insulation films, and in particular to a glass insulation film that utilizes negative ions to remove formaldehyde and a preparation method thereof.

### BACKGROUND

Traditional glass has excellent light transmission, but poor thermal insulation. During the daytime, the sunlight enters through doors and windows, causing the indoor temperature to rise. In summer, various cooling methods need to be adopted to conduct cooling. However, at night, indoor heat would be lost through the doors and windows, such that heating measures are required to ensure indoor temperature stability. Therefore, an extremely enormous amount of energy has been dissipated by doors and windows.

Currently, glass films are widely used in building doors and windows around the world for thermal insulation. Alternatively, the thermal insulation is conducted using low-emissivity glass or vacuum laminated glass. Alternatively, the thermal insulation could also be accomplished by pasting an insulation film on the glass to reduce the transmission of heat radiation or by using heat-absorbing glass. Glass insulation film, a commonly used film, could effectively block solar radiation. At the same time, the glass insulation film could also improve the safety of glass by reducing splashing when the glass is broken by external force. Existing glass films are limited to effectively block ultraviolet rays and infrared light. However, these glass films do not have the ability to remove formaldehyde contained in consumer products such as some interior decoration materials, furniture, and specially-finished clothing fabrics. For the removal of indoor formaldehyde, most indoor formaldehyde purification devices require physical and chemical methods separately, which greatly increases the cost of use.

### SUMMARY

In view of this, to solve the problems existing in the prior art, the present disclosure provides a glass film that is light-transmitting, heat-insulating, and capable of removing indoor formaldehyde, and a preparation method thereof.

To achieve the above object, the present disclosure adopts the following technical solutions:

Provided is a glass insulation film that utilizes negative ions to remove formaldehyde, the glass insulation film being a composite film with a layered structure, where the layered structure includes a transparent film substrate, an insulation coating, an anion coating, and a protective film layer in sequence from bottom to top that are integrally formed.

In some embodiments, the transparent film substrate is selected from the group consisting of a polyvinyl chloride (PVC) film, a polyvinyl butyral (PVB) film, a polycarbonate (PC) film, a polyethylene (PE) film, a polypropylene (PP) film, and a polyethylene terephthalate (PET) film.

In some embodiments, the protective film layer is a polyester film coated on both sides with silicone release agents.

In some embodiments, the insulation coating is obtained by coating a mixture of a nanopowder material, ethyl acetate, polyvinyl alcohol, an ultraviolet absorber, and a curing agent on a surface of the transparent film substrate, and then subjecting the mixture to high-temperature curing.

In some embodiments, the nanopowder material is obtained by compounding a nano-antimony tin oxide (ATO) or a nano-indium tin oxide (ITO) with a nanocellulose.

In some embodiments, the mixture for forming the insulation coating includes the following components in parts by weight: 10 parts to 30 parts of the nanopowder material, 20 parts to 40 parts of the ethyl acetate, 15 parts to 35 parts of the polyvinyl alcohol, 1 part to 2 parts of the ultraviolet absorber, and 1.5 parts to 2.5 parts of the curing agent; the nanopowder material is obtained by compounding the nano-ATO or the nano-ITO with the nanocellulose at a weight ratio of (40-45):(30-35); and the mixture for forming the insulation coating is formed by a process including: selecting the components in the parts by weight, placing the nanopowder material and the ethyl acetate in an ultrasonic device, then conducting ultrasonic treatment at room temperature for 10 min to obtain a first mixture, and heating the first mixture to 40° C.; adding the polyvinyl alcohol and the ultraviolet absorber into the first mixture to obtain a second mixture, subjecting the second mixture to magnetic stirring for 1 h, and cooling to room temperature; and adding the curing agent into the second mixture to obtain a third mixture, and subjecting the third mixture to magnetic stirring for 30 min to obtain the mixture for forming the insulation coating for later use.

In some embodiments, the anion coating is obtained by coating a mixture of a tourmaline anion powder, a modified brucite powder, titanium dioxide, a silane coupling agent, and a polyurethane adhesive on a surface of the insulation coating, and then subjecting the mixture to high-temperature curing.

In some embodiments, the mixture for forming the anion coating includes the following components in parts by weight: 10 parts to 20 parts of the tourmaline anion powder, 1 part to 5 parts of the modified brucite powder, 1 part to 2 parts of the silane coupling agent, 30 parts to 40 parts of absolute ethanol, 2 parts to 3 parts of the titanium dioxide, and 40 parts to 50 parts of the polyurethane adhesive; and the mixture for forming the anion coating is formed by a process including: selecting the components in the parts by weight; pouring the tourmaline anion powder into a grinding jar, and adding grinding balls to perform ball milling for 0.5 h to obtain a ball milled tourmaline anion powder; and adding the silane coupling agent, the absolute ethanol, and the titanium dioxide into the ball milled tourmaline anion powder to continue the ball milling for 20 min, and adding the modified brucite powder and the polyurethane adhesive thereto to continue the ball milling at a speed of 30 r/min for 2 h to obtain the mixture for forming the anion coating for later use.

Further provided is a method for preparing the glass insulation film that utilizes negative ions to remove formaldehyde, including the following steps:
step 1: cleaning the transparent film substrate, and drying in an oven at 45° C.;
step 2: coating the mixture for forming the insulation coating evenly on the surface of the transparent film substrate with a coater, and subjecting the mixture for forming the insulation coating to curing at a temperature of 120° C. to 130° C. for 100 s to 110 s to form the insulation coating;
step 3: coating the mixture for forming the anion coating evenly on the surface of the insulation coating with the coater, and subjecting the mixture for forming the anion coating to curing at a temperature of 100° C. to 110° C. for 120 s to 130 s to form the anion coating; and
step 4: compounding the protective film layer on a surface of the anion coating to obtain the glass insulation film that utilizes negative ions to remove formaldehyde.

It can be seen from the above technical solutions that the present disclosure provides a glass insulation film that utilizes negative ions to remove formaldehyde and a preparation method thereof. In the present disclosure, the glass insulation film that utilizes negative ions to remove formaldehyde has a composite structure, which includes a transparent film substrate, an insulation coating, an anion coating, and a protective film layer in sequence from bottom to top that are integrally formed. Each of the layers shows a mutual synergistic effect, such that the glass insulation film not only has high light transmittance and desirable insulation and ultraviolet protection properties, but also shows an excellent formaldehyde removal ability. Therefore, the glass insulation film could better meet the needs of consumers.

Compared with the prior art, the present disclosure has the following technical effects:

1. Compared with traditional architectural glass insulation films, the glass insulation film of the present disclosure is compounded with a layer of anion coating. The anion coating is obtained by coating a mixture of a tourmaline anion powder, a modified brucite powder, titanium dioxide, a silane coupling agent, and a polyurethane adhesive on a surface of the insulation coating, and subjecting the mixture to high-temperature curing. The anion powder and the titanium dioxide could play a significant role in decomposing formaldehyde after photocatalysis; and the modified brucite powder could increase light transmittance of the anion coating, such that a finally prepared composite film could still maintain high light transmittance.

2. In the present disclosure, the insulation coating in the glass insulation film is obtained by coating a mixture of a nanopowder material, ethyl acetate, polyvinyl alcohol, an ultraviolet absorber, and a curing agent on a surface of the transparent film substrate, and then subjecting the mixture to high-temperature curing. Compared with the existing technology, in the present disclosure, the mixture for forming the insulation coating is prepared by compounding a nano-ATO or a nano-ITO and a nanocellulose to obtain a mixed material, and hybridizing the mixed material with the polyvinyl alcohol to form a film, which could greatly improve the strength, flexibility, and superplasticity of the material. Meanwhile, the material has high thermal stability, thermal insulation, and anti-ultraviolet aging stability, as well as excellent mechanical properties. Since the compounded nanoparticle material forms nanoscale pores on the surface of the insulation coating, and the material itself shows an extremely low volume density, the insulation coating contains a large number of particles inside that reflect and scatter infrared light, such that a selective and effective blocking effect on infrared rays could be achieved, and at the same time, the light transmittance of the product is not affected. Moreover, based on the natural characteristics of nanocellulose, the glass insulation film could exhibit certain disintegration properties and recyclability, and is more environmentally friendly.

### DETAILED DESCRIPTION OF THE EMBODIMENTS

The present disclosure provides a glass insulation film that utilizes negative ions to remove formaldehyde, the glass insulation film being a composite film with a layered structure, wherein the layered structure includes a transparent film substrate, an insulation coating, an anion coating, and a protective film layer in sequence from bottom to top that are integrally formed.

In some embodiments of the present disclosure, the transparent film substrate is selected from the group consisting of a PVC film, a PVB film, a PC film, a PE film, a PP film, and a PET film.

In some embodiments of the present disclosure, the protective film layer is a polyester film coated on both sides with a silicone release agent.

In some embodiments of the present disclosure, the insulation coating is obtained by coating a mixture of a nanopowder material, ethyl acetate, polyvinyl alcohol, an ultraviolet absorber, and a curing agent on a surface of the transparent film substrate, and then subjecting the mixture to high-temperature curing; where the ultraviolet absorber is a type commonly used in the field, such as UV-326, UV-531, and T-571; and the curing agent is a type commonly used in the field, such as SAC12.

In some embodiments of the present disclosure, the mixture for forming the insulation coating includes the following components in parts by weight: 10 parts to 30 parts of the nanopowder material, 20 parts to 40 parts of the ethyl acetate, 15 parts to 35 parts of the polyvinyl alcohol, 1 part to 2 parts of the ultraviolet absorber, and 1.5 parts to 2.5 parts of the curing agent; the nanopowder material is obtained by compounding the nano-ATO or the nano-ITO with the nanocellulose at a weight ratio of (40-45):(30-35). The mixture for forming the insulation coating is prepared by a process including: selecting the components in the parts by weight; placing the nanopowder material and the ethyl acetate in an ultrasonic device, then conducting ultrasonic treatment at room temperature for 10 min to obtain a first mixture, and heating the first mixture to 40° C.; adding the polyvinyl alcohol and the ultraviolet absorber into the first mixture to obtain a second mixture, subjecting the second mixture to magnetic stirring for 1 h, and cooling to room temperature; and adding the curing agent into the second mixture to obtain a third mixture, and subjecting the third mixture to magnetic stirring for 30 min to obtain the mixture for forming the insulation coating for later use.

In some embodiments of the present disclosure, the anion coating is obtained by coating a mixture of a tourmaline anion powder, a modified brucite powder, titanium dioxide, a silane coupling agent, and a polyurethane adhesive on a surface of the insulation coating, and then subjecting the mixture to curing; where the silane coupling agent is a commonly used type in the field, such as KH-570.

In some embodiments of the present disclosure, the mixture for forming the anion coating includes the following components in parts by weight: 10 parts to 20 parts of the tourmaline anion powder, 1 part to 5 parts of the modified brucite powder, 1 part to 2 parts of the silane coupling agent, 30 parts to 40 parts of absolute ethanol, 2 parts to 3 parts of the titanium dioxide, and 40 parts to 50 parts of the polyurethane adhesive; and the mixture for forming the anion coating is prepared by a process including: selecting the components in the parts by weight, pouring the tourmaline anion powder into a grinding jar, and adding grinding balls to perform ball milling for 0.5 h to obtain a ball milled tourmaline anion powder; and adding the silane coupling agent, the absolute ethanol, and the titanium dioxide into the ball milled tourmaline anion powder to continue the ball milling for 20 min, and adding the modified brucite powder and the polyurethane adhesive thereto to continue the ball milling at a speed of 30 r/min for 2 h to obtain the mixture for forming the anion coating for later use.

The modified brucite powder is modified by a transition metal according to a modification method described in the literature “Changye Mang, Guanghui Li, Mingjun Rao, Xin Zhang, Jun Luo; Environmental Science and Pollution Research volume 29, pages 49739-49751 (2022) Cite this article; Transition metal ions-modified birnessite toward highly efficiency photocatalytic formaldehyde oxidation under visible light irradiation”.

The present disclosure further provides a method for preparing the glass insulation film that utilizes negative ions to remove formaldehyde, including the following steps:
step 1: cleaning the transparent film substrate, and drying in an oven at 45° C.;
step 2: coating the mixture for forming the insulation coating evenly on the surface of the transparent film substrate with a coater, and subjecting the mixture for forming the insulation coating to curing at a temperature of 120° C. to 130° C. for 100 s to 110 s to form the insulation coating;
step 3: coating the mixture for forming the anion coating evenly on the surface of the insulation coating with the coater, and subjecting the mixture for forming the anion coating to curing at a temperature of 100° C. to 110° C. for 120 s to 130 s to form the anion coating; and
step 4: compounding the protective film layer on a surface of the anion coating to obtain the glass insulation film that utilizes negative ions to remove formaldehyde.

The technical solutions in the embodiments of the present disclosure will be clearly and completely described below. Apparently, the described embodiments are merely a part of, not all of, the embodiments of the present disclosure. All other embodiments obtained by those skilled in the art based on the embodiments of the present disclosure without creative efforts shall fall within the scope of the present disclosure.

### Example 1

This example provided a glass insulation film that utilizes negative ions to remove formaldehyde. The glass insulation film was a composite film with a layered structure, where the layered structure was composed of a transparent film substrate, an insulation coating, an anion coating, and a protective film layer in sequence from bottom to top that were integrally formed.

The transparent film substrate was a PE film; and the protective film layer was a polyester film coated on both sides with a silicone release agent.

The insulation coating was obtained by coating a mixture of a nanopowder material, ethyl acetate, polyvinyl alcohol, an ultraviolet absorber, and a curing agent on a surface of the transparent film substrate, and then subjecting the mixture to high-temperature curing; and the nanopowder material was obtained by compounding a nano-ATO with a nanocellulose.

The anion coating was obtained by coating a mixture of a tourmaline anion powder, a modified brucite powder, titanium dioxide, a silane coupling agent, and a polyurethane adhesive on a surface of the insulation coating, and then subjecting the mixture to high-temperature curing.

In this example, the mixture for forming the insulation coating was composed of the following components in parts by weight: 10 parts of the nanopowder material, 20 parts of the ethyl acetate, 15 parts of the polyvinyl alcohol, 1 part of the ultraviolet absorber (T-571, produced by BASF AG in Germany), and 1.5 parts of the curing agent (SAC12, produced by Xi'an Aerospace Sunvalor Chemical Co., Ltd.). The nanopowder material was obtained by compounding the nano-ATO with the nanocellulose at a weight ratio of 40:30. The mixture for forming the insulation coating was prepared as follows: the components in the parts by weight were selected, the nanopowder material and the ethyl acetate were placed in an ultrasonic device, and then subjected to ultrasonic treatment at room temperature for 10 min to obtain a first mixture, and the first mixture was heated to 40° C.; the polyvinyl alcohol and the ultraviolet absorber were added into the first mixture to obtain a second mixture, and the second mixture was subjected to magnetic stirring for 1 h, and then cooled to room temperature; and the curing agent was added into the second mixture to obtain a third mixture, and the third mixture was subjected to magnetic stirring for 30 min to obtain the mixture for forming the insulation coating for later use.

In this example, the mixture for forming the anion coating was composed of the following components in parts by weight: 10 parts of the tourmaline anion powder, 1 part of the modified brucite powder, 1 part of the silane coupling agent (KH570, industrial grade-I, Nanjing USI Chemical Co., Ltd.), 30 parts of absolute ethanol, 2 parts of the titanium dioxide, and 40 parts of the polyurethane adhesive. The mixture for forming the anion coating was prepared as follows: the components in the parts by weight were selected, the tourmaline anion powder was poured into a grinding jar, grinding balls were added to perform ball milling for 0.5 h to obtain a ball milled tourmaline anion powder; and the silane coupling agent, the absolute ethanol, and the titanium dioxide were added into the ball milled tourmaline anion powder to continue the ball milling for 20 min, and the polyurethane adhesive was added thereto to continue the ball milling at 30 r/min for 2 h to obtain the mixture for forming the anion coating for later use.

This example further provided a method for preparing the glass insulation film that utilizes negative ions to remove formaldehyde, which was performed as follows:
step 1: the transparent film substrate was cleaned, and dried in an oven at 45° C.;
step 2: the mixture for forming the insulation coating was coated evenly on the surface of the transparent film substrate with a coater, and then subjected to curing at 120° C. for 100 s to form the insulation coating;
step 3: the mixture for forming the anion coating was coated evenly on the surface of the insulation coating with the coater, and then subjected to curing at 100° C. for 120 s to form the anion coating; and
step 4: the protective film layer was compounded on a surface of the anion coating to obtain the glass insulation film that utilizes negative ions to remove formaldehyde.

### Example 2

This example provided a glass insulation film that utilizes negative ions to remove formaldehyde. The glass insulation film was a composite film with a layered structure, where the layered structure was composed of a transparent film substrate, an insulation coating, an anion coating, and a protective film layer in sequence from bottom to top that were integrally formed.

The transparent film substrate was a PVC film; and the protective film layer was a polyester film coated on both sides with a silicone release agent.

The insulation coating was obtained by coating a mixture of a nanopowder material, ethyl acetate, polyvinyl alcohol, an ultraviolet absorber, and a curing agent on a surface of the transparent film substrate, and then subjecting the mixture to high-temperature curing; and the nanopowder material was obtained by compounding a nano-ITO with a nanocellulose.

The anion coating was obtained by coating a mixture of a tourmaline anion powder, a modified brucite powder, titanium dioxide, a silane coupling agent, and a polyurethane adhesive on a surface of the insulation coating, and then subjecting the mixture to high-temperature curing.

In this example, the mixture for forming the insulation coating was composed of the following components in parts by weight: 30 parts of the nanopowder material, 40 parts of the ethyl acetate, 35 parts of the polyvinyl alcohol, 2 parts of the ultraviolet absorber (T-571, produced by BASF AG in Germany), and 2.5 parts of the curing agent (SAC12, produced by Xi'an Aerospace Sunvalor Chemical Co., Ltd.). The nanopowder material was obtained by compounding the nano-ITO with the nanocellulose at a weight ratio of 45:35. The mixture for forming the insulation coating was prepared as follows: the components in the parts by weight were selected, the nanopowder material and the ethyl acetate were placed in an ultrasonic device, and then subjected to ultrasonic treatment at room temperature for 10 min to obtain a first mixture, and the first mixture was heated to 40° C.; the polyvinyl alcohol and the ultraviolet absorber were added into the first mixture to obtain a second mixture, the second mixture was subjected to magnetic stirring for 1 h, and then cooled to room temperature; and the curing agent was added into the second mixture to obtain a third mixture, and the third mixture was subjected to magnetic stirring for 30 min to obtain the mixture for forming the insulation coating for later use.

In this example, the mixture for forming the anion coating was composed of the following components in parts by weight: 20 parts of the tourmaline anion powder, 5 parts of the modified brucite powder, 2 parts of the silane coupling agent (KH570, industrial grade-I, Nanjing USI Chemical Co., Ltd.), 40 parts of absolute ethanol, 3 parts of the titanium dioxide, and 50 parts of the polyurethane adhesive. The mixture for forming the anion coating was prepared as follows: the components in the parts by weight were selected, the tourmaline anion powder was poured into a grinding jar, grinding balls were added to perform ball milling for 0.5 h to obtain a ball milled tourmaline anion powder; and the silane coupling agent, the absolute ethanol, and the titanium dioxide were added into the ball milled tourmaline anion powder to continue the ball milling for 20 min, and the polyurethane adhesive and modified brucite powder were added thereto to continue the ball milling at 30 r/min for 2 h to obtain the mixture for forming the anion coating for later use.

This example further provided a method for preparing the glass insulation film that utilizes negative ions to remove formaldehyde, which was performed as follows:
step 1: the transparent film substrate was cleaned, and dried in an oven at 45° C.;
step 2: the mixture for forming the insulation coating was coated evenly on the surface of the transparent film substrate with a coater, and then subjected to curing at 130° C. for 110 s to form the insulation coating;
step 3: the mixture for forming the anion coating was coated evenly on the surface of the insulation coating with the coater, and then subjected to curing at 110° C. for 130 s to form the anion coating; and
step 4: the protective film layer was compounded on a surface of the anion coating to obtain the glass insulation film that utilizes negative ions to remove formaldehyde.

### Example 3

This example provided a glass insulation film that utilizes negative ions to remove formaldehyde. The glass insulation film was a composite film with a layered structure, where the layered structure was composed of a transparent film substrate, an insulation coating, an anion coating, and a protective film layer in sequence from bottom to top that were integrally formed.

The transparent film substrate was a PET film; and the protective film layer was a polyester film coated on both sides with a silicone release agent.

The insulation coating was obtained by coating a mixture of a nanopowder material, ethyl acetate, polyvinyl alcohol, an ultraviolet absorber, and a curing agent on a surface of the transparent film substrate, and then subjecting the mixture to high-temperature curing.

The anion coating was obtained by coating a mixture of a tourmaline anion powder, a modified brucite powder, titanium dioxide, a silane coupling agent, and a polyurethane adhesive on a surface of the insulation coating, and then subjecting the mixture to high-temperature curing.

The nanopowder material was obtained by compounding a nano-ATO with a nanocellulose.

In this example, the mixture for forming the insulation coating was composed of the following components in parts by weight: 20 parts of the nanopowder material, 30 parts of the ethyl acetate, 25 parts of the polyvinyl alcohol, 1.5 parts of the ultraviolet absorber (T-571, produced by BASF AG in Germany), and 2 parts of the curing agent (SAC12, produced by Xi'an Aerospace Sunvalor Chemical Co., Ltd.). The nanopowder material was obtained by compounding the nano-ATO with the nanocellulose at a weight ratio of 42:32. The mixture for forming the insulation coating was prepared as follows: the components in the parts by weight were selected, the nanopowder material and the ethyl acetate were placed in an ultrasonic device, and then subjected to ultrasonic treatment at room temperature for 10 min to obtain a first mixture, and the first mixture was heated to 40° C.; the polyvinyl alcohol and the ultraviolet absorber were added into the first mixture to obtain a second mixture, the second mixture was subjected to magnetic stirring for 1 h, and then cooled to room temperature; and the curing agent was added into the second mixture to obtain a third mixture, and the third mixture was subjected to magnetic stirring for 30 min to obtain the mixture for forming the insulation coating for later use.

In this example, the mixture for forming the anion coating was composed of the following components in parts by weight: 15 parts of the tourmaline anion powder, 4 parts of the modified brucite powder, 1.5 part of the silane coupling agent (KH570, industrial grade-I, Nanjing USI Chemical Co., Ltd.), 35 parts of absolute ethanol, 2.5 parts of the titanium dioxide, and 45 parts of the polyurethane adhesive. The mixture for forming the anion coating was prepared as follows: the components in the parts by weight were selected, the tourmaline anion powder was poured into a grinding jar, grinding balls were added to perform ball milling for 0.5 h to obtain a ball milled tourmaline anion powder; and the silane coupling agent, the absolute ethanol, and the titanium dioxide were added into the ball milled tourmaline anion powder to continue the ball milling for 20 min, and the polyurethane adhesive or acrylate adhesive was added thereto to continue the ball milling at 30 r/min for 2 h to obtain the mixture for forming the anion coating for later use.

This example further provided a method for preparing the glass insulation film that utilizes negative ions to remove formaldehyde, which was performed as follows:
step 1: the transparent film substrate was cleaned, and dried in an oven at 45° C.;
step 2: the mixture for forming the insulation coating was coated evenly on the surface of the transparent film substrate with a coater, and then subjected to curing at 125° C. for 105 s to form the insulation coating;
step 3: the mixture for forming the anion coating was coated evenly on the surface of the insulation coating with the coater, and then subjected to curing at 105° C. for 125 s to form the anion coating; and
step 4: the protective film layer was compounded on a surface of the anion coating to obtain the glass insulation film that utilizes negative ions to remove formaldehyde.

The properties of the glass insulation films that utilize negative ions to remove formaldehyde prepared in Examples 1 to 3 and those of a commercially available insulation film were tested, and the results are shown in Table 1.

TABLE 1

| Test item | Example 1 | Example 2 | Example 3 | 3M film |
|---|---|---|---|---|
| Visible light transmittance | 85.1% | 85.5% | 86.8% | 86.1% |
| (%) | | | | |
| Near-infrared transmittance | 14.8% | 14.3% | 14.1% | 21.5% |
| (%) | | | | |
| Ultraviolet transmittance | 0.8% | 0.5% | 0.3% | 4.5% |
| (%) | | | | |
| Formaldehyde removal | 95.1% | 95.9% | 97.8% | 0 |
| efficiency (%) | | | | |

As shown in the results of Table 1, the glass insulation film that utilizes negative ions to remove formaldehyde prepared in the present disclosure could not only effectively block infrared rays, showing a significant insulation performance, but also block ultraviolet rays, and at the same time shows high light transmittance and formaldehyde removal properties.

Each example in the description is described in a progressive mode, each example focuses on differences from other examples, and references can be made to each other for the same and similar parts between examples.

The above description of the disclosed embodiments enables those skilled in the art to achieve or use the present disclosure. Various modifications to these embodiments are readily apparent to those skilled in the art, and the generic principles defined herein may be practiced in other embodiments without departing from the spirit or scope of the present disclosure. Accordingly, the present disclosure will not be limited to these examples shown herein, but is to fall within the widest scope consistent with the principles and novel features disclosed herein.

What is claimed is:

1. A glass insulation film that utilizes negative ions to remove formaldehyde, the glass insulation film being a composite film with a layered structure, wherein the layered structure comprises a transparent film substrate, an insulation coating, an anion coating, and a protective film layer in sequence from bottom to top that are integrally formed;
wherein the insulation coating is obtained by coating a mixture of a nanopowder material, ethyl acetate, polyvinyl alcohol, an ultraviolet absorber, and a curing agent on a surface of the transparent film substrate, and then subjecting the mixture to curing; and the nanopowder material is obtained by compounding a nano-antimony tin oxide (ATO) or a nano-indium tin oxide (ITO) with a nanocellulose; and
the anion coating is obtained by coating a mixture of a tourmaline anion powder, a modified brucite powder, absolute ethanol, titanium dioxide, a silane coupling agent, and a polyurethane adhesive on a surface of the insulation coating, and then subjecting the mixture to curing.

2. The glass insulation film that utilizes negative ions to remove formaldehyde of claim 1, wherein the transparent film substrate is selected from the group consisting of a polyvinyl chloride (PVC) film, a polyvinyl butyral (PVB) film, a polycarbonate (PC) film, a polyethylene (PE) film, a polypropylene (PP) film, and a polyethylene terephthalate (PET) film.

3. The glass insulation film that utilizes negative ions to remove formaldehyde of claim 1, wherein the protective film layer is a polyester film coated on both sides with a silicone release agent.

4. The glass insulation film that utilizes negative ions to remove formaldehyde of claim 1, wherein the mixture for forming the insulation coating comprises the following components in parts by weight: 10 parts to 30 parts of the nanopowder material, 20 parts to 40 parts of the ethyl acetate, 15 parts to 35 parts of the polyvinyl alcohol, 1 part to 2 parts of the ultraviolet absorber, and 1.5 parts to 2.5 parts of the curing agent.

5. The glass insulation film that utilizes negative ions to remove formaldehyde of claim 1, wherein the mixture for forming the anion coating comprises the following components in parts by weight: 10 parts to 20 parts of the tourmaline anion powder, 1 part to 5 parts of the modified brucite powder, 1 part to 2 parts of the silane coupling agent, 30 parts to 40 parts of absolute ethanol, 2 parts to 3 parts of the titanium dioxide, and 40 parts to 50 parts of the polyurethane adhesive.

6. The glass insulation film that utilizes negative ions to remove formaldehyde of claim 1, wherein the nanopowder material is obtained by compounding the nano-ATO or the nano-ITO with the nanocellulose at a weight ratio of (40-45):(30-35).

7. The glass insulation film that utilizes negative ions to remove formaldehyde of claim 4, wherein the mixture for forming the insulation coating is prepared by a process comprising:
selecting the components in the parts by weight;
placing the nanopowder material and the ethyl acetate in an ultrasonic device, then conducting ultrasonic treatment at room temperature for 10 min to obtain a first mixture, and heating the first mixture to 40° C.;
adding the polyvinyl alcohol and the ultraviolet absorber into the first mixture to obtain a second mixture, subjecting the second mixture to magnetic stirring for 1 h, and cooling to room temperature; and
adding the curing agent into the second mixture to obtain a third mixture, and subjecting the third mixture to magnetic stirring for 30 min to obtain the mixture for forming the insulation coating for later use.

8. The glass insulation film that utilizes negative ions to remove formaldehyde of claim 5, wherein the mixture for forming the anion coating is prepared by a process comprising:
selecting the components in the parts by weight;
pouring the tourmaline anion powder into a grinding jar, and adding grinding balls to perform ball milling for 0.5 h to obtain a ball milled tourmaline anion powder; and
adding the silane coupling agent, the absolute ethanol, and the titanium dioxide into the ball milled tourmaline anion powder to continue the ball milling for 20 min, and adding the modified brucite powder and the polyurethane adhesive thereto to continue the ball milling at a speed of 30 r/min for 2 h to obtain the mixture for forming the anion coating for later use.

9. A method for preparing the glass insulation film that utilizes negative ions to remove formaldehyde of claim 1, comprising the following steps:
step 1: cleaning the transparent film substrate, and drying in an oven at 45° C.;
step 2: coating the mixture for forming the insulation coating on the surface of the transparent film substrate with a coater, and subjecting the mixture for forming the insulation coating to curing at a temperature of 120° C. to 130° C. for 100 s to 110 s to form the insulation coating;
step 3: coating the mixture for forming the anion coating on the surface of the insulation coating with the coater, and subjecting the mixture for forming the anion coating to curing at a temperature of 100° C. to 110° C. for 120 s to 130 s to form the anion coating; and
step 4: compounding the protective film layer on a surface of the anion coating to obtain the glass insulation film.

10. The method of claim 9, wherein the transparent film substrate is selected from the group consisting of a polyvinyl chloride (PVC) film, a polyvinyl butyral (PVB) film, a polycarbonate (PC) film, a polyethylene (PE) film, a polypropylene (PP) film, and a polyethylene terephthalate (PET) film.

11. The method of claim 9, wherein the protective film layer is a polyester film coated on both sides with a silicone release agent.

12. The method of claim 9, wherein the mixture for forming the insulation coating comprises the following components in parts by weight: 10 parts to 30 parts of the nanopowder material, 20 parts to 40 parts of the ethyl acetate, 15 parts to 35 parts of the polyvinyl alcohol, 1 part to 2 parts of the ultraviolet absorber, and 1.5 parts to 2.5 parts of the curing agent.

13. The method of claim 9, wherein the mixture for forming the anion coating comprises the following components in parts by weight: 10 parts to 20 parts of the tourmaline anion powder, 1 part to 5 parts of the modified brucite powder, 1 part to 2 parts of the silane coupling agent, 30 parts to 40 parts of absolute ethanol, 2 parts to 3 parts of the titanium dioxide, and 40 parts to 50 parts of the polyurethane adhesive.

14. The method of claim 9, wherein the nanopowder material is obtained by compounding the nano-ATO or the nano-ITO with the nanocellulose at a weight ratio of (40-45):(30-35).

15. The method of claim 12, wherein the mixture for forming the insulation coating is prepared by a process comprising:
selecting the components in the parts by weight;
placing the nanopowder material and the ethyl acetate in an ultrasonic device, then conducting ultrasonic treatment at room temperature for 10 min to obtain a first mixture, and heating the first mixture to 40° C.;
adding the polyvinyl alcohol and the ultraviolet absorber into the first mixture to obtain a second mixture, subjecting the second mixture to magnetic stirring for 1 h, and cooling to room temperature; and
adding the curing agent into the second mixture to obtain a third mixture, and subjecting the third mixture to magnetic stirring for 30 min to obtain the mixture for forming the insulation coating for later use.

16. The method of claim 13, wherein the mixture for forming the anion coating is prepared by a process comprising:
selecting the components in the parts by weight;
pouring the tourmaline anion powder into a grinding jar, and adding grinding balls to perform ball milling for 0.5 h to obtain a ball milled tourmaline anion powder; and
adding the silane coupling agent, the absolute ethanol, and the titanium dioxide into the ball milled tourmaline anion powder to continue the ball milling for 20 min, and adding the modified brucite powder and the polyurethane adhesive thereto to continue the ball milling at a speed of 30 r/min for 2 h to obtain the mixture for forming the anion coating for later use.
